(19) United States
(12) Patent Application Publication
(10) Pub. No.: US 2007/0229558 A1
(43) Pub. Date: Oct. 4, 2007

(54) Image Viewing Control

(75) Inventors: David Stewart Brettle, Leeds (GB); Sarah Elizabeth Bacon, Leeds (GB)

Correspondence Address: KIRTON AND MCCONKIE, 60 EAST SOUTH TEMPLE,, SUITE 1800, SALT LAKE CITY, UT, 84111, US

(73) Assignee: THE LEEDS TEACHING HOSPITALS NHS TRUST, Leeds (GB)

(21) Appl. No.: 11/572,831

(22) PCT Filed: Jul. 27, 2005
(86) PCT No.: PCT/GB05/02949

§ 371 Date: Mar. 28, 2007

(30) Foreign Application Priority Data
Jul. 29, 2004 (GB) 0416904.1

(51) Int. Cl. H04N 17/04

(52) U.S. Cl. 345/904

(57) ABSTRACT

A computer implemented method, computer program, data processing device and user interface for controlling display of an image by a program on display device are described. The method includes detecting a command to cause the program to display the image. A password for the program is displayed on the display in a format that depends on at least one characteristic relating to the image quality of the display such that the password can only be perceived by the user if the display is configured to allow the image to be viewed reliably. The program is allowed to display the image if a password entered by the user corresponds to the displayed password and is not allowed to display the image if a password entered by the user does not correspond to the displayed password.

The present invention relates to controlling the viewing of images, and in particular to methods, apparatus, user interfaces, computer program code and computer program products for controlling the display of images by computer programs on display devices.

The usefulness of an image displayed by a computer program on a display device depends on a number of factors. The quality of the eyesight and visual capacity of the user has an effect. Also, the level and nature of lighting can have an effect. Further, physical properties of the display device, such as the devices inherent quality, the type of display technology (e.g. CRT, LCD, plasma), the resolution, the reflectivity of the screen, etc, can also have an effect. There are also the settings of the display device, such as brightness, the contrast and colour which have an effect on the image that is displayed.

The overall usefulness of a displayed image is therefore dependent on how the image is displayed, the environment in which the image is displayed and the eyesight of the person viewing and working from the image, whether the image be a picture, graphical, textural or a combination thereof. A number of these factors are within a users control, although not all users may be aware of the impact of these factors on their work quality.

One particular area in which image quality is of importance is in medical applications, in which images of body parts can be used by medical practitioners in making judgements and decisions on the diagnosis and treatment of patients. However, there can be a tendency for busy practitioners to use any available display to view images rather than either only using dedicated image viewing displays or checking the configuration of non-dedicated image viewing displays, e.g. a personal computer monitor, to ensure that they are suitable for reliably viewing images and are that the display settings are optimised for reliably viewing images.

In some instances, it can be desirable to have somebody view an image at a location remote to the image, e.g. to have an expert in a first hospital view an image captured in a second hospital over a computer network and advise thereon. However, there is no mechanism for ensuring that the remotely viewed image is being viewed in a reliable manner.

A system exists in which remotely stored medical images can be accessed over a computer network wherein a gray scale is displayed to a user so that the user can change their monitor settings if they choose. However, this does not prevent the viewing of images in an unreliable manner.

Hence, it is often the case that images are viewed and assessed in an unreliable manner. There is therefore a need for a mechanism by which the viewing of images in an unreliable manner can be controlled.

The present invention provides a method for preventing a user viewing an image using a computer program, by password protecting the program and displaying the password in a form that can only be read by the user if the quality of the displayed image is sufficiently high. Hence access to images by either persons whose eyesight is not sufficient or by persons using displays with incorrect settings, or having an inherently low image quality, is prevented.

According to an aspect of the invention, there is provided a method for controlling the display of an image by a computer program on a display device. The method can comprise displaying a password in a format in which the password is only perceivable to a user if the display device is configured to display the image at a reliable quality. The computer program can only be allowed to display the image if the user enters a password corresponding to the displayed password.

Hence, if the display is not of sufficiently high quality to allow the password to be perceived by a user, display of the image on the display is prevented.

According to a further aspect of the present invention, there is provided a computer implemented method for controlling display of an image by a program on a data processing device, the data processing device having a display on which an image can be displayed by the program to a user. The method can comprise detecting a command to cause the program to display the image. A password for the program can be displayed on the display. The password can be displayed in a format that depends on at least one characteristic relating to the image quality of the display such that the password can only be perceived by the user if the display is configured to allow the image to be viewed reliably. The program can be allowed to display the image if a password entered by the user corresponds to the displayed password and the program can be prevented from displaying the image if a password entered by the user does not correspond to the displayed password.

Allowing the program to display the image can include running the program or allowing the program to keep running. Not allowing the program to display the image can include not running the program or stopping or closing the program if it has already started running.

The password can have a single element or a plurality of elements. Preferably at least two elements are provided. More preferably the password includes four elements. The or each element can be displayed exhibiting a different degree of the characteristic. The characteristic can be selected from any one or combination of: contrast; brightness; intensity; colour; hue; luminance; spatial resolution; and temporal resolution.

Each element can include a randomly selected symbol. The symbol can be any indicia, such as a character, letter, numeral, mark, icon or similar.

Each element can include a background portion and a symbol. Different elements can have backgrounds exhibiting different degrees of the characteristic.

The password can include four elements. A first element can have a 0% pixel intensity background, a second and a third element can have 50% pixel intensity backgrounds and a fourth element can have a 100% pixel intensity background.

The program can be any program that displays or controls the display of an image. An image can include both graphical or pictorial images as well as textural images and/or combinations thereof. The program can be a viewer specially configured for viewing image files and in a preferred embodiment is specially configured for viewing medical images, especially gray scale images. The medical images can be the result of any medical imaging modality, such as ultrasound, magnetic resonance, computer tomography, nuclear medicine, X-ray, X-ray fluoroscopy and similar.

The method can further comprise displaying an indication of the acceptable uses of the display to the user. This helps to improve governance by ensuring that images are only accessible if the display device will render them with a sufficiently high quality.

The method can further comprise displaying an indication of optimal display settings to the user. Hence, if the display settings of the display device have been changed from optimal the user can easily set the display device to its optimal configuration for displaying images which may lead to a password being perceivable when next displayed.

The method can further comprise displaying a further password for the program on the display if it is determined that the password entered by the user does not correspond to the displayed password. Hence the user can be given multiple opportunities to enter the correct password. The further password can be different to the previous password. This can help to prevent the user entering the correct password by chance thereby improving the robust ness of the login procedure. The further passwords can be displayed a set number of times. For example the user can be presented with e.g. two, three, four or five different passwords before a further password is not displayed.

According to a further aspect of the invention, there is provided a controlled image display data processing device, the data processing device having a display on which an image can be displayed by a program to a user. The data processing device can be configured to detect a command to cause the program to display the image. A password for the program can be displayed on the display. The password can be displayed in a format that depends on at least one characteristic relating to the image quality of the display such that the password can only be perceived by the user if the display is configured to allow the image to be viewed reliably. The program can be allowed to display the image if a password entered by the user corresponds to the displayed password and the program can be prevented from displaying the image if a password entered by the user does not correspond to the displayed password.

According to a further aspect of the invention, there is provided a computer system comprising at least one data processing device according to the preceding aspect of the invention in communication over a network with a server storing a plurality of images which can be viewed using the program.

According to a further aspect of the invention, there is provided a user interface to a program for displaying an image on a display. The user interface can comprise a password displayed in a format that depends on at least one characteristic relating to the image quality of the display such that the password can only be perceived by a user if the display is configured to allow the image to be viewed reliably. The user interface can further comprise an input mechanism by which a password can be entered by a user. The input mechanism can include a field for entering a password.

According to a further aspect of the invention there is provided computer program code executable by a data processor to provide the method, the data processing device, the computer system or the user interface aspects of the invention. There is also provided a computer program product comprising a computer readable medium or media bearing between them such computer program code.

According to a further aspect of the invention, there is provided a method for controlling the viewing of images displayed on a display device by a computer program. The method can include determining optimum values for display settings for the display device by viewing a test image on the display device. A password can be displayed on the display device using the optimum values. The password can be displayed in a format that depends on at least one characteristic relating to the image quality of the display. A visual property of the password can be varied until the password is just perceivable to a user so as to provide a threshold value for the property. A login protocol or process can be associated with the computer program. The login protocol can control display of images by the computer program and can display a password for the program using the calibrated characteristics such that the password can only be perceived by the user if the display is configured to allow an image to be viewed reliably.

An embodiment of the invention will now be described, by way of example only, and with reference to the accompanying drawings, in which:

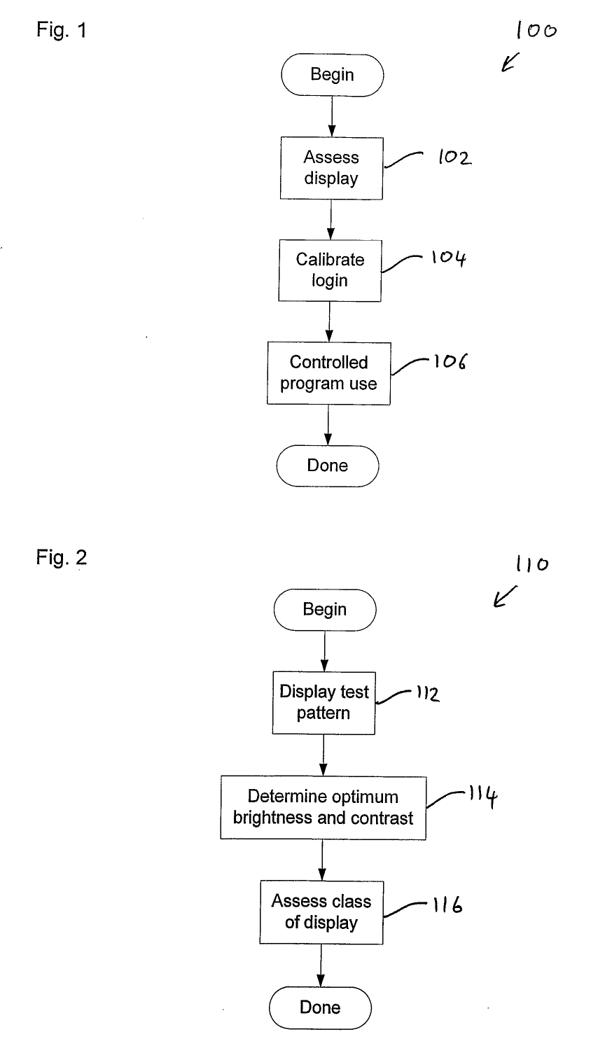

FIG. 1 shows a high level flow chart illustrating a general image viewing control method of the invention;

FIG. 2 shows a flow chart illustrating a display device assessment method of the invention and being a part of the method illustrated in FIG. 1;

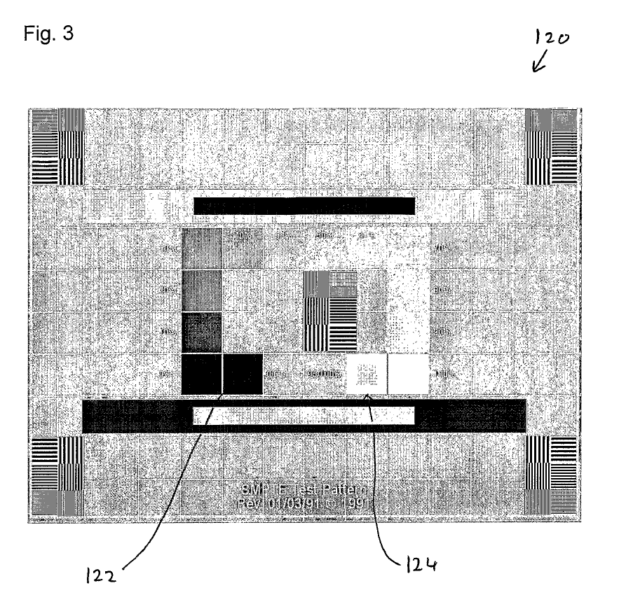

FIG. 3 shows a screen shot of a test image used in the display device assessment method illustrated in FIG. 2;

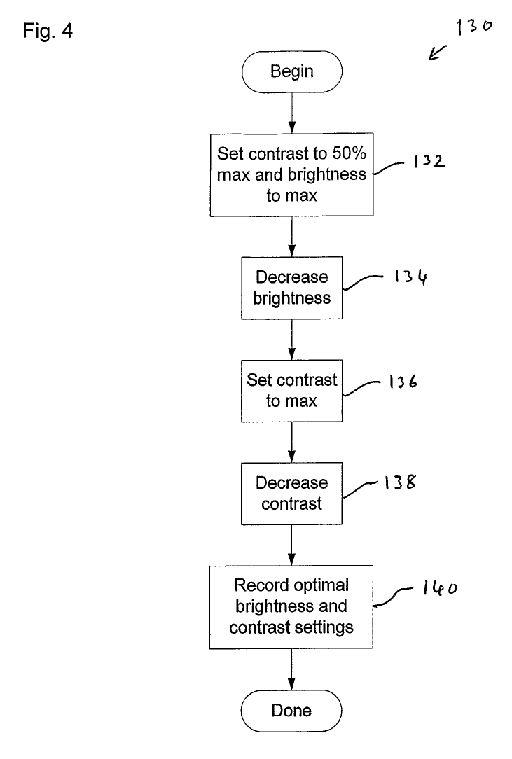

FIG. 4 shows a flow chart illustrating a display setting optimisation step of the method illustrated in FIG. 2;

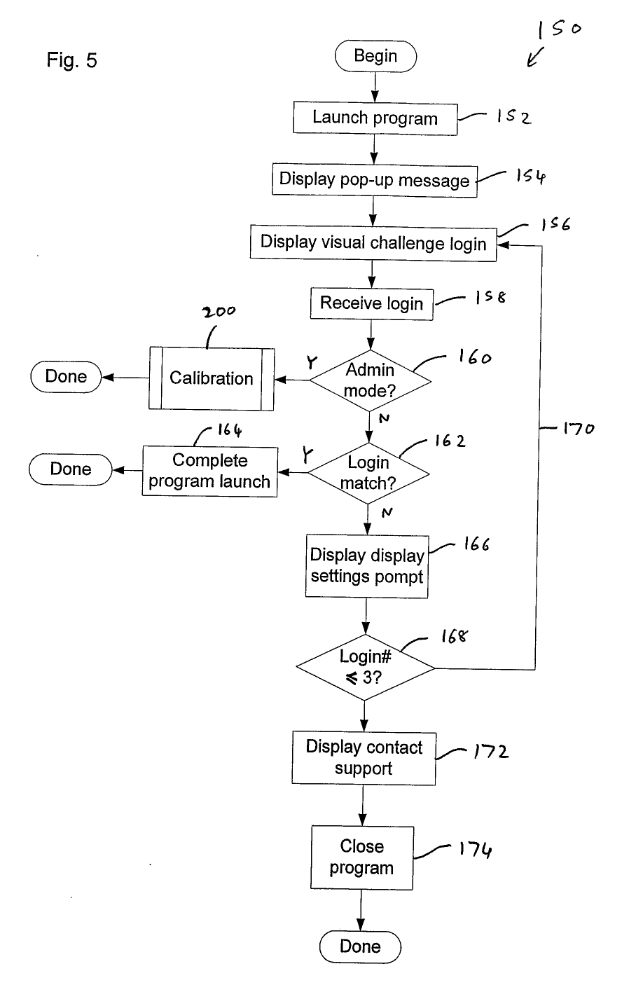

FIG. 5 shows a flow chart illustrating a program use control method of the invention;

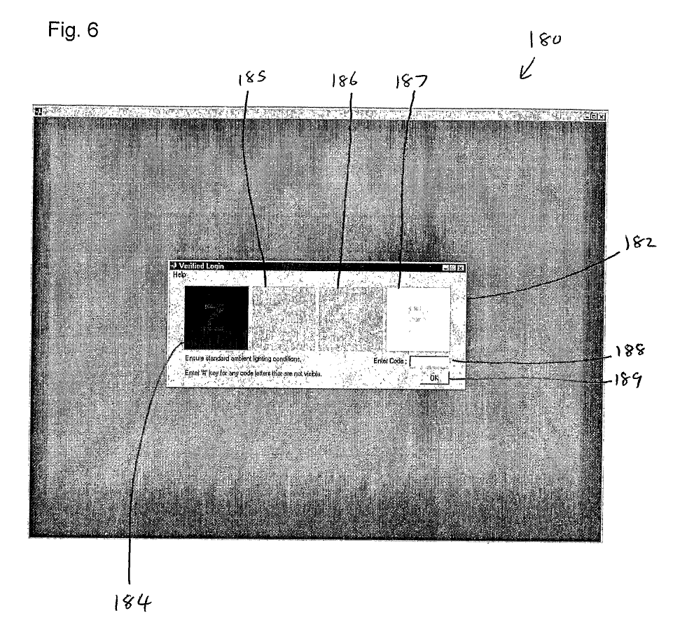

FIG. 6 shows a screen shot of a user interface part of a login protocol of the invention;

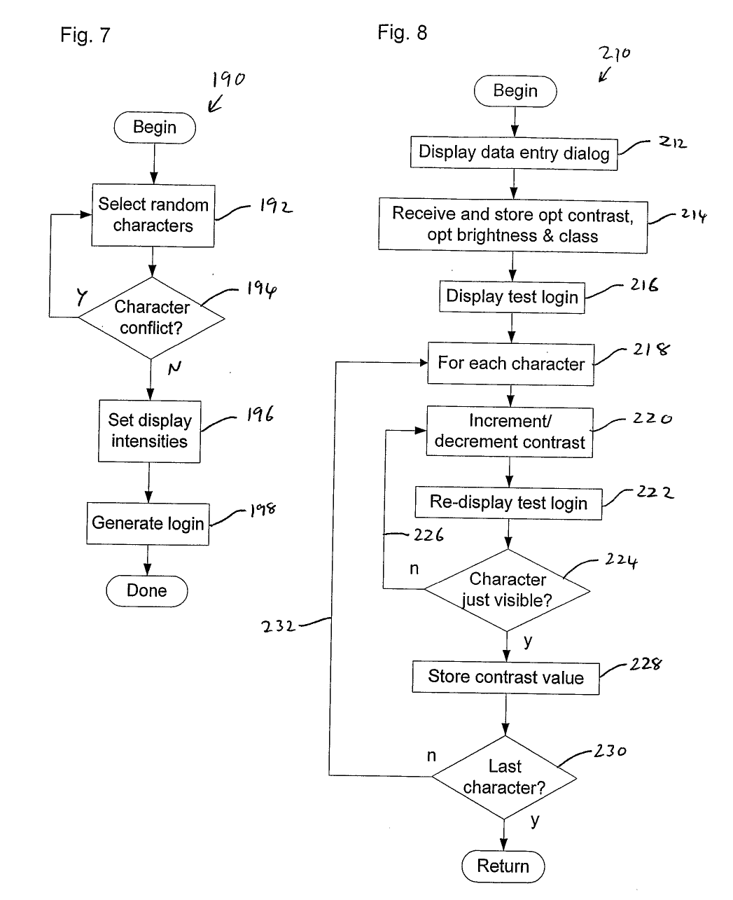

FIG. 7 shows a flow chart illustrating a user interface generation process of the method illustrated in FIG. 5;

FIG. 8 shows a login calibration process of the method illustrated in FIG. 5;

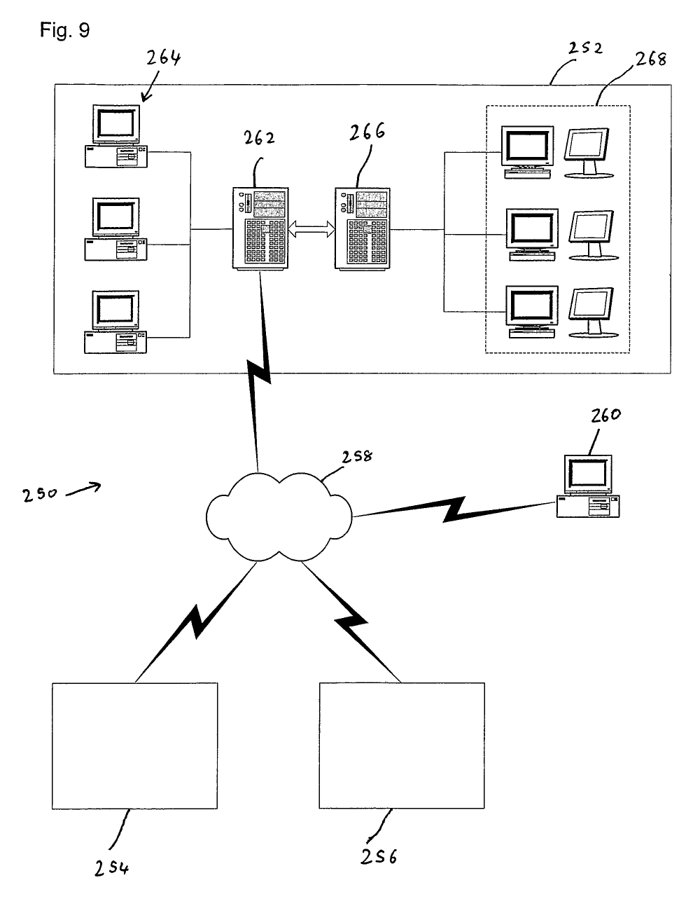

FIG. 9 shows a schematic block diagram of a computer system according to the invention; and

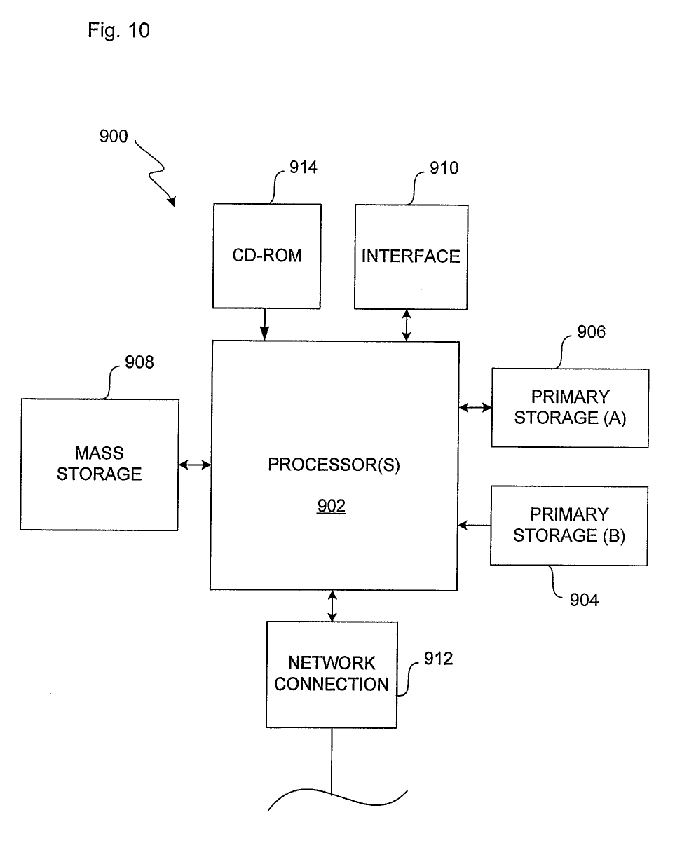

FIG. 10 shows a schematic block diagram of a data processing device according to the invention.

Similar items in different Figures share common reference numerals unless indicated otherwise.

The invention will be described within the context of a medical application, but it will be appreciated that the invention's utility it not limited to that particular field which will be apparent from the following discussion.

With reference to FIG. 1, there is shown a flowchart illustrating a general method for controlling the viewing of images 100 according to the invention and including stages according to further aspects of the invention. The overall method 100 includes a number of stages. In a first stage 102, the performance of a display device, e.g. the monitor of a computer, is assessed in order to determine the optimum display settings for the monitor and also the types of images which the monitor can reliably be used to view. Once the assessment of the display device has been completed, at stage 104, an administration or set-up mode of a login program is used to calibrate the login to the properties of the display device for the computer on which an application program associated with the login is to be run. The login program controls access to the application so as to prevent images being viewed using the program, if the display can not display images of sufficient quality. In the following, although the discussion will refer to medical images, ‘images’ is considered to include graphical and textural elements, and indeed any image that can be displayed on a display device either by, or under control of, a computer program. After the login has been calibrated at step 104, the computer system has been configured and at a ready for use stage 106, wherein use of the computer program to view images is controlled by the associated login program, as will be described in greater detail below.

With reference to FIG. 2, there is shown a flowchart illustrating a method 110 for carrying out the display assessment step 102 of method 100. A technician or administrator, having good eyesight, carries out the display assessment method. At step 112, a test image is displayed on the display device of the computer. A screen shot of a suitable test pattern 120 is illustrated in FIG. 3. This particular test pattern 120 is the widely available SMPTE test pattern. After the test pattern has been displayed on the monitor, at step 114, the optimum brightness and contrast settings for the display device, or monitor, are determined at step 114.

FIG. 4 shows a flowchart illustrating a method 130 for determining the optimum brightness and contrast settings for the display device in greater detail. At step 132, the technician uses the display device controls to set the display device's contrast to 50% of its maximum contrast and sets the display device's brightness to its maximum setting. The test pattern 120 includes a 0/5% square 122. A 0% pixel intensity corresponds to a pixel being entirely off and hence a black display region. A 100% pixel intensity corresponds to a pixel being entirely on and hence a white display region. The 0/5% square has a black border with a central square region having 5% of the maximum pixel intensity. At step 134, the brightness control of the display device is operated to decrease the brightness until the outer black region of the 0/5% square just begins to turn from grey to black, without losing contrast with the inner lighter square.

Then with the brightness control fixed, at step 136, the contrast control is operated to increase the contrast of the display device to its maximum setting. The test pattern 130 also includes a 95/100% square 124. This square has an outer region at 100% pixel intensity and an inner region at 95% pixel intensity. At step 138, the display device controls are used to decrease the contrast setting until the outer white region of the 95/100% square stops glaring but remains reasonably bright with good contrast between the inner darker square and the outer perimeter. Once the set up of the monitor has been completed, the optimal brightness and contrast settings are recorded at step 140 for this particular display device.

Returning to FIG. 2, method 110 proceeds with an optional step 116 of assessing the class of the display. An assessment of the displayed test image can be carried out based on the judgement of the technician as to the suitability of the display. For example it may be that the display device does not exhibit sufficient contrast quality for use in clinical diagnosis, and should only be used for viewing text. Therefore at step 11, the technician can, using the test pattern, assess the quality of the display device and classify the display device in a class, or range of classes, of acceptable use or uses of the display device.

After the display assessment step has been completed, the login prologue to the image viewer application program is calibrated to the display device, with the display device set at its optimum brightness and contrast settings. As mentioned above, the login calibration is carried out as an administration or set-up process within the login program. FIG. 5 shows a process flowchart illustrating data processing operations carried out by the login program 150. The login program is associated with an image viewing or display application to be executed by the computer to which the display device is attached.

In order to facilitate explanation, the use of the login program to control image display by the application program will first be described, corresponding to stage 106 of method 100, before returning to a description of the process used in the login calibration stage 104. At step 152, the login program detects or otherwise determines that the application viewer program has been called. Launch of the application program is allowed to initialise, but is not allowed to complete.

At step 154, a message can optionally be displayed to the user, stating the acceptable uses of the computer system for displaying images, e.g. “This computer may be used for review purposes only and not for reporting purposes”. The pop-up message can be generated by checking for a stored display class identifier data item which has previously been entered during the login calibration process and by the technician following their assessment of the class of the display as carried out at step 116 of method 110. The display class identifier data item can be used to identify the message to be displayed in the pop-up message overlayed over the launching application. This provides good clinical governance as users cannot claim not to know for which purposes the computer system use has been approved.

After the pop-up message has been displayed, at step 156, a login user interface is displayed. FIG. 6 shows a screen shot 180 of the login user interface 182 and FIG. 7 shows a flowchart illustrating the process 190 for creating and displaying the login user interface 182 in greater detail.

Login user interface 182 displays a password which, if the display is suitable for the purpose required by the viewing application, should just be perceptible to a user having adequate eye sight. In the illustrated embodiment, the password consists of four characters or symbols, each of which is displayed on its own background. A first element of the password 184 has a black background (i.e. 0% pixel intensity) and a first symbol displayed thereon. A second element of the password 185 has a grey 50% pixel intensity background (50% above 0%) and a second symbol displayed thereon. A third element 186 also has a grey 50% pixel intensity background (50% down from 100%) with a third symbol displayed thereon. A fourth element 187 has a white 100% pixel intensity background with a fourth symbol displayed thereon.

Although four password elements are described, it will be appreciated that fewer or more password elements can also be used. It is preferred to include at least a password element having a black background and a password element having a white background as these help to test the upper and lower limits of the range of display behaviour

User interface 182 also includes a field 188 into which a user can enter a password and a button 189 which, when activated, enters the password into the computer. The user interface is provided in the form of a dialogue box overlayed over a window for the associated application.

With reference to FIG. 7, the process for creating the login user interface 182 is described in greater detail. At step 192, four symbols are selected at random, to form the password. Symbols can include alphanumeric characters, punctuation marks and any other indicia that can be entered from a computer keyboard or other input device.

Optionally, at step 194, it can be determined whether there is a conflict between some of the characters selected for the password. A character conflict can be considered to occur when two or more of the characters are similarly shaped. For example, an “O” character and an “D” can be considered to be similar. It is preferred not to include both of those characters in the same password as the password will not be testing the perception of the viewer as accurately compared to differently shaped characters. Similarly, an “I” and an “L” character or an “E” and an “F” character may be considered to be too similar. IT can also be possible to exclude some characters from being selected. For example, characters whose shape or appearance are such that they are not suitable for testing the display characteristic, e.g. contrast, may be excluded from selection either by not being available for selection or by being discarded if they are selected. If it is determined at step 194 that the password does include characters which are too similar, then process flow can return to step 192 at which other characters are selected at random to replace the conflicting characters in the password until an acceptable password has been generated.

At step 196, for each of the characters of the password, the program looks up the appropriate pixel intensity for that character, in relation to the background on which the character is to be displayed. The character intensities for each background are determined during the calibration process and are stored in the login program at that time as will be described in greater detail below. Then at step 198, any other operations required to generate the user interface login box 182 are carried out and then the login box is displayed to the user in a window overlaid on the application window.

Returning to FIG. 5, at step 158, the program receives the login password entered by the user. At step 160, it is determined whether the password entered by the user corresponds to a code indicating that the program should enter the administration or set-up mode. If the entered password does correspond to the administration code, then process flow branches and the calibration process 200 begins.

If the password does not correspond to the administration code, then process flow proceeds to step 162 at which it is determined whether the password entered by the user matches the displayed password. This is likely to be the case only if the combination of the set-up of the display device and the user's eyesight are sufficient for the user to have been able to perceive the barely visible password characters. This can be considered to show that the display and user are sufficient to allow images to be reliably displayed and perceived and so at step 164, launch of the application program to display images is completed. The login protocol then ends and process control resides with the application program.

If at step 162 it is determined that the entered password does not correspond to the displayed password, then process flow proceeds to step 166 at which the program can display a message to the user including the optimal contrast and brightness settings for the display device so that the user can ensure that the display device is at its optimum settings. If not the display device's controls can be used to set the display device at its optimum settings. However, step 166 is optional and is not essential.

Process flow then proceeds to step 168 at which the login program 150 determines whether the user has already failed the login process a number of times previously. For example, in the illustrated embodiment, if the number of the login attempt is less than or equal to three, then process flow branches as indicated by line 170 and returns to step 156 at which a new random password is generated and displayed. Hence, the user is allowed three attempts to logon and use the application program. Fewer or more than three attempts can be permitted in other embodiments. The use of a fixed number of login attempts helps to prevent chance and guesses allowing a user to use a program they would otherwise not be allowed to use. This feature is preferred but not essential.

If at step 168 it is determined that the user has exceeded their fixed number of login attempts, then process flow proceeds to step 172 and a message can be displayed to the user indicating that they should contact support staff. This step is also optional, but helps to maintain integrity of the system by helping to identify users persistently failing to use appropriate hardware for viewing images and also to help identify any monitors which are either incorrectly set up or are being used for incorrect purposes. Then at step 174, the application program is closed down to prevent its use by the user. The login process 150 then terminates and process control is returned to the operating system.

As will be appreciated, this login protocol helps to control the use of programs for viewing images so that images are only viewed on computer systems by users wherein the quality of the image being viewed and perceived by the user is of an acceptably high quality or standard. Hence, this provides a mechanism for ensuring that important decisions based on a quantitative or qualitative assessment of images displayed by, or under control of, a computer are only carried out when the displayed image is of a sufficiently high quality thereby improving the reliability and validity of the decisions made on the basis of those assessments.

With reference to FIG. 8, there is shown a flowchart illustrating the calibration process 210 carried out at step 200 in FIG. 5. As explained above, the calibration process 210 is entered when a technician or administrator enters a specific code into the login user interface. A check can be included in process 190 to generate a further selection of random characters if the password initially generated accidentally coincides with the set-up code. When the login program 150 is first run, default values can be used for the display intensities for the password elements and for any other data items required by the login program. However, these data items will typically be set by a technician when first calibrating and configuring the login program.

At step 212, the program displays a window with fields for receiving various data items from the technician, including a data item identifying the assessed display class of the monitor, a data item indicating the optimal contrast setting for the monitor and a data item indicating the optimal brightness setting for the monitor. A user ID data item and data items providing a link to the program with which the login is associated can also be entered. This would allow an audit of who has used the software and optionally could provide restricted user access by comparing the user ID data item with a restricted user list against which access is also verified. At step 214, these data items are received by the program and stored. At step 216, a test login dialogue is generated, using a process similar to process 190, but using default character intensity values, and the test login is displayed to the technician.

With the display device configured at the optimal brightness and contrast settings, a test password is displayed together with buttons or other control elements to allow the technician to increase or decrease the intensity of the displayed character relative to the background on which it is being displayed. For example an increment and a decrement button can be displayed adjacent each of the elements of the password to allow the technician to step through a plurality of fixed increments and decrements, e.g. 5%, 2%, 1%, 0.8%, 0.6%, 0.4%, 0.3%, 0.2%, 0.1% and 0% of maximum grey level relative to each background. In another embodiment a continuous range is used rather than a discrete range. For the black background element and the second background (50% above 0%) the grey level values are added to the grey level values for the backgrounds. For the white background and the third background (50% down from 100%) elements, the character grey values are subtracted from the grey level values of the backgrounds.

A threshold character intensity at which the character is just distinguishable from its back ground is determined. For each character 218, the character pixel intensity value is increased or decreased 220 by the technician and the test password is re-displayed 222 with the new character pixel intensity setting. The technician determines whether the character is still visible and if so process flow returns 226 to step 220 at which the pixel intensity value is decreased again. If the character is no longer visible, then the technician can increase the character pixel intensity by one step and that pixel intensity can be stored 228 as the threshold pixel intensity value for that character for that background. Steps 220-228 are then repeated 232 for the next character, until threshold pixel intensity values for each character have been determined and stored.

For example, the character on the black background can initially be displayed at a pixel intensity of 5% of the maximum pixel intensity on the black background. The technician can then reduce the intensity of the display character until the step at which the character can no longer be distinguished from its background is reached. The technician can then increase the intensity of the pixel by one step so as to identify the character pixel intensity corresponding to the limit of perception. This process is carried out for each of the characters until a threshold intensity for each of the characters, relative to its background has been determined. After the threshold intensity values have been determined, they are stored in the login program. The calibration process is then completed and the visual password protected application program is now ready for use.

FIG. 9 shows a schematic block diagram of an example computer system 250 in which the login method of the present invention can be used. Computer system 250 includes a first hospital 252, a second hospital 254 and a further hospital or other medical institute 256 each of which includes a respective computer system and all in communication via the Internet 258. Computer system 250 can also include a home or remote computer 260 associated with an individual, e.g. a consultant or other medical practitioner. First hospital 252 has a computer network, including a web server 262 to which an intranet 264 of general purpose computers is connected. Web server 262 can be in communication with a dedicated image handling server 266, such as a PACS (Picture Archive and Communications Systems) server. PACS server 266 can be in communication with a network of specialised image viewing computer systems 268 for a specific user sub-group, such as radiologists.

A radiologist may be provided with a dedicated computer system including a separate high quality display device being specially configured for the display of high quality medical images, using which the radiologist can carry out reporting activities, such as the rendering of expert opinions based on an assessment of displayed of X-ray images. As the radiologists have access to sufficiently high quality image display computer systems, there is no requirement for the login protocol of the present invention to be installed on those systems.

However, the display devices for such systems tend to be very expensive and so are not appropriate for general use throughout the hospital. Further, there is a tendency for other practitioners, such as surgeons and doctors, to access images stored on PACS server via a local general purpose machine over the hospital intranet 264. Hence, the login program of the present invention can be used on the machines of the hospital's general intranet to control the display of images served from the PACS server 266. Hence, using the present invention, hospital 252 can help prevent decision and judgements being made based on improperly viewed images.

The invention has further benefits and utility. For example, if remote computer 260 is local to a consultant whose opinion is required on a medical image, then the login program can be used with the consultant's remote machine 260 to ensure that the consultant can only render his opinion provided his local display is of sufficient quality. Hence, the activities of the consultant can be controlled by the hospital 252, even though he is not local to the hospital, to ensure quality levels are met.

Similarly, it may be that a practitioner in the second hospital 254 may need access to images stored on PACS server 266. The PACS server 266 can serve the images to a local machine in hospital 254. However, by using the login program of the present invention with the application on the local computer for viewing the served images, again, the clinician's actions can be controlled to ensure that assessments are only carried out if images of a sufficiently high quality have been displayed. Similarly, medical institute or research laboratory 256, can also have local computers with the login program of the present invention associated with local image viewing applications so as to control the use of those applications by staff at that institute when attempting to view images served from hospital 252.

There are a number of ways in which the program of the present invention can be implemented in practice. In a thick client model, the login program and associated application can be installed locally on each client machine. In an alternative, thin client approach, a file can be stored on each local machine including data items indicating the optimal contrast, optimal brightness, display device class, and threshold intensities for each of the elements of the password. The login program can then be provided as an applet, e.g. a Java applet, to the remote client machine from web server 262, and provided the login procedure is passed, the desired images can be served via web server 262 to the remote client machine. In a further embodiment, the web server can store a file for each client machine including the data items required by the login program for that machine and can use the IP address or some other identifier of the remote client machine to identify the appropriate settings for the login applet for the remote client machine.

The invention has been described above in the context of medical images and a medical image handling system. For example, the invention could be used to control access to images resulting from various imaging modalities, such as magnetic resonance, computer tomography, ultrasound, nuclear medicine, pulse X-ray and X-ray fluoroscopy. However, the method is not limited to those images only and has utility for other image types, such as pathology slides, smear test slides and other laboratory type images. Indeed, the invention is of general utility in research and can be used, e.g., in connection with microscopy. A display device can be used to display a magnified image. The login protocol of the present invention can be used to ensure the quality of the displayed image by preventing the user of the microscope from displaying images on a display device for assessment unless the login protocol of the present invention has been passed. In this embodiment, the associated computer program is controlling the display of the image, rather than generating the image itself.

The invention is further not limited simply to medical applications and will be of benefit in any industry in which the quality of images being displayed by a display device is important in order to allow a quantitative or qualitative assessment to be made based on the displayed image. For example, the method of the present invention could be of use in legal proceedings to ensure the quality of displayed images, e.g. from security or CCTV cameras. Hence, in this such applications, the login protocol has a forensic character. The invention could also be used in graphic design or printing applications in order to ensure proof quality. The invention can also be of use in material science applications, such as disaster investigation studies, or in other engineering applications.

The described embodiment involves a password formatted to relate to the contrast characteristic of a display device. However, the invention is not limited to that characteristic of a display device. In other embodiments, the password can be displayed in a format related to the spatial resolution of the display device and observer and in other embodiments to the temporal resolution of the display device and observer, e.g. a flicker sensitivity. Further, the password can be displayed in a format to exploit any combination of these display characteristics. Indeed the password can be displayed and formatted in any manner in order to provide a visual structure sensitive to the property of the display and/or observer being tested.

For example, a 3D login user interface could be provided with a 3D display device. Typically, 3D display devices use multiple screens and display temporally displaced images so as to make the human mind believe it is observing a three dimensional object. In order to ensure that a user and/or the display devices are creating an accurate three dimensional image, the password user interface can be formatted so that it is on the boundary of perception as a 3D image. Therefore, if the user cannot discern the three dimensional password, it can be assumed that the user and/or display system are not appropriately configured for displaying a high quality three dimensional image and so the login process could be determined to fail.

Generally, embodiments of the present invention employ various processes involving data stored in or transferred through one or more computer systems. Embodiments of the present invention also relate to an apparatus for performing these operations. This apparatus may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps. A particular structure for a variety of these machines will appear from the description given below.

In addition, embodiments of the present invention relate to computer readable media or computer program products that include program instructions and/or data (including data structures) for performing various computer-implemented operations. Examples of computer-readable media include, but are not limited to, magnetic media such as hard disks, floppy disks, and magnetic tape; optical media such as CD-ROM disks; magneto-optical media; semiconductor memory devices, and hardware devices that are specially configured to store and perform program instructions, such as read-only memory devices (ROM) and random access memory (RAM). The data and program instructions of this invention may also be embodied on a carrier wave or other transport medium. Examples of program instructions include both machine code, such as produced by a compiler, and files containing higher level code that may be executed by the computer using an interpreter.

FIG. 10 illustrates a typical computer system that, when appropriately configured or designed, can serve as an image analysis apparatus of this invention. The computer system 900 includes any number of processors 902 (also referred to as central processing units, or CPUs) that are coupled to storage devices including primary storage 906 (typically a random access memory, or RAM), primary storage 904 (typically a read only memory, or ROM). CPU 902 may be of various types including microcontrollers and microprocessors such as programmable devices (e.g., CPLDs and FPGAs) and unprogrammable devices such as gate array ASICs or general purpose microprocessors. As is well known in the art, primary storage 904 acts to transfer data and instructions uni-directionally to the CPU and primary storage 906 is used typically to transfer data and instructions in a bi-directional manner. Both of these primary storage devices may include any suitable computer-readable media such as those described above. A mass storage device 908 is also coupled bi-directionally to CPU 902 and provides additional data storage capacity and may include any of the computer-readable media described above. Mass storage device 908 may be used to store programs, data and the like and is typically a secondary storage medium such as a hard disk. It will be appreciated that the information retained within the mass storage device 908, may, in appropriate cases, be incorporated in standard fashion as part of primary storage 906 as virtual memory. A specific mass storage device such as a CD-ROM 914 may also pass data uni-directionally to the CPU.

CPU 902 is also coupled to an interface 910 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 902 optionally may be coupled to an external device such as a database or a computer or telecommunications network using an external connection as shown generally at 912. With such a connection, it is contemplated that the CPU might receive information from the network, or might output information to the network in the course of performing the method steps described herein.

Although the above has generally described the present invention according to specific processes and apparatus, the present invention has a much broader range of applicability. In particular, aspects of the present invention is not limited to any particular kind of display device characteristic and can use a password formatted to relate to any display device characteristic which is involved in perceived image quality. Further, the invention is not limited to medical images and can be of use in any application in which a quantitative or qualitative assessment of a displayed image is of benefit. One of ordinary skill in the art would recognize other variants, modifications and alternatives in light of the foregoing discussion.

It will be appreciated that the flowcharts illustrating the operations carried out are schematic and that certain of the operations may be omitted or the sequence changed or merged into other operations while still meeting the general teaching of the invention herein. Therefore the flowcharts are not intended to limit the invention to the specific flow of processing and operations illustrated.

In view of the description of the invention included herein, numerous additional embodiments and variations on the discussed embodiments of the present invention will be apparent to one of ordinary skill in the art. It is to be understood that such embodiments do not depart from the present invention and are to be considered within the scope of the invention.

1. A computer implemented method for controlling display of an image by a program on a data processing device, the data processing device having a display on which the image can be displayed by the program to a user, the method comprising:
detecting a command instructing the program to display the image;
displaying a password for the program on the display, the password being displayed in a format that depends on at least one characteristic relating to the image quality of the display such that the password can only be perceived by the user if the display is configured to allow the image to be viewed reliably; and
allowing the program to display the image if a password entered by the user corresponds to the displayed password and not allowing the program to display the image if a password entered by the user does not correspond to the displayed password.

2. A method as claimed in claim 1, wherein the password has a plurality of elements and each element is displayed exhibiting a different degree of the characteristic.

3. A method as claimed in claim 2, wherein each element includes a randomly selected symbol.

4. A method as claimed in claim 2, wherein each element includes a background portion and a symbol.

5. A method as claimed in claim 4, wherein the password includes four elements, a first element having a 0% pixel intensity background, a second and a third element having 50% pixel intensity backgrounds and a fourth element having a 100% pixel intensity background.

6. A method as claimed in claim 1, wherein the characteristic is contrast.

7. A method as claimed in claim 1, wherein the characteristic is brightness.

8. A method as claimed in claim 1, wherein the program is a viewer for medical images.

9. A method as claimed in claim 1, and further comprising displaying an indication of the acceptable uses of the display to the user.

10. A method as claimed claim 1, and further comprising displaying an indication of optimal display settings to the user.

11. A method as claimed in claim 1, and further comprising:
displaying a further password for the program on the display, different to the previous password if it is determined that the password entered by the user does not correspond to the displayed password.

12. A method as claimed in claim 11, wherein further passwords are displayed a set number of times.

13. A controlled image display data processing device, the data processing device having a display on which an image can be displayed by a program to a user, the data processing device being configured to:
detect a command instructing the program to display the image;
display a password for the program on the display, the password being displayed in a format that depends on at least one characteristic relating to the image quality of the display such that the password can only be perceived by the user if the display is configured to allow the image to be viewed reliably; and
allow the program to display the image if a password entered by the user corresponds to the displayed password and not allow the program to display the image if a password entered by the user does not correspond to the displayed password.

14. A computer system comprising at least one data processing device as claimed in claim 13 in communication over a network with a server storing a plurality of images which can be viewed using the program.

15. A user interface to a program for displaying an image on a display, the user interface comprising:
a password displayed in a format that depends on at least one characteristic relating to the image quality of the display such that the password can only be perceived by a user if the display is configured to allow the image to be viewed reliably; and
an input mechanism by which a password can be entered by the user.

16. Computer program code executable by a data processor to provide the method of claim 1.

17. A computer program product comprising a computer readable medium bearing computer program code as claimed in claim 16.

18. A method for controlling the viewing of images displayed on a display device by a computer program, the method comprising:
determining optimum values for display settings for the display device by viewing a test image on the display device;
displaying a password on the display device using the optimum values, the password being displayed in a format that depends on at least one characteristic relating to the image quality of the display;
varying a visual property of the password until the password is just perceivable to a user so as to provide a threshold value for the property; and
associating a login protocol with the computer program, wherein the login protocol controls use of the computer program and displays a password for the program using the threshold value such that the password can only be perceived by the user if the display is configured to allow an image to be viewed reliably.

19. A method for controlling the display of an image by a computer program on a display device, the method comprising:
displaying a password in a format in which the password is only perceivable to a user if the display device is configured to display the image at a reliable quality; and
only allowing the computer program to cause the image to be displayed if the user enters a password corresponding to the displayed password.

20. (canceled)

21. (canceled)

22. (canceled)
